(19) United States
(12) Patent Application Publication
(10) Pub. No.: US 2005/0172113 A1
(43) Pub. Date: Aug. 4, 2005

(54) Method and apparatus for basic input output system loading

(75) Inventor: Chang-Hwa Lee, Cupertino, CA (US)

Correspondence Address: VEDDER PRICE KAUFMAN & KAMMHOLZ, 222 N. LASALLE STREET, CHICAGO, IL, 60601, US

(73) Assignee: ATI Technologies, Inc., Markham (CA)

(21) Appl. No.: 10/768,783

(22) Filed: Jan. 30, 2004

(51) Int. Cl. G06F 15/177

(52) U.S. Cl. 713/2

(57) ABSTRACT

A method and apparatus for basic input/output system (BIOS) loading includes a graphics processor performing a startup operation. The method and apparatus further includes this central processing unit (CPU) having a cache memory disposed therein. The method and apparatus provides for the graphic processor writing data to the cache memory prior to the execution of the startup operations such that the graphics processor may effectively and efficiently use the expanded memory resources of the cache memory prior to the CPU allocating and utilizing the CPU-specific resources. As such, the method and apparatus allows for improved BIOS loading by allowing for a greater degree of flexibility with an improved amount of available memory resources.

### FIELD OF THE INVENTION

The present invention relates generally to basic input output system loading and more specifically to basic input output system loading in a personal computer system in conjunction with a cache memory unit.

### BACKGROUND OF THE INVENTION

In a standard computing system, the basic input output system (BIOS) software is the pre-operating software which is utilized to setup and establish memory allocations from a program to execute on the actual hardware device, such as a central processing unit (CPU). In setting up any processing system, the BIOS software operates to establish initial memory allocations. A typical BIOS software is any available software package from any suitable vendor such as for exemplary purposes only, cME TrustedCore available from Phoenix Technologies.

Presently, typical BIOS software implementations do not use cache memory as data and stack segments to implement the system memory initialization and sizing. The system BIOS software must use the CPU registers to implement memory initialization and sizing. Based on the limited amount of register space, the allocation and operations for the memory initialization and sizing can be problematic.

For example, with utilizing only CPU registers for data and stack segments, some CPU instructions, such as call, push and pop, cannot be used. Furthermore, as these standard CPU instructions cannot be used, this provides further complications in the development, debugging and maintenance of the BIOS software.

In a personal computer system, the system BIOS must use the CPU registers as buffers to save data and to process data without data and stack segment. Therefore, system BIOS software must very carefully control how the limited amount of registers within the CPU are used and allocated during system memory initialization and sizing.

Therefore, there exists a need for BIOS loading in a personal computer operating in conjunction with a CPU, wherein the BIOS loading allows for greater memory access for improved memory initialization and sizing operations.

### BRIEF DESCRIPTION OF THE DRAWINGS

FIG. 1 illustrates a graphical representation of a block diagram of an apparatus for BIOS loading in accordance with one embodiment of the present invention;

FIG. 2 illustrates a method for BIOS loading in accordance with one embodiment of the present invention;

FIG. 3 illustrates another embodiment of an apparatus for BIOS loading in accordance with another embodiment of the present invention; and

FIG. 4 illustrates a flowchart of another method for BIOS loading in accordance with another embodiment of the present invention.

### DETAILED DESCRIPTION OF A PREFERRED EMBODIMENT

Generally, a method and apparatus for BIOS loading includes a graphics processor having a start-up operations, for the graphics processor may be, but not limited to, a single processor, a plurality of processors, a DSP, a microprocessor, ASIC, state machine, or any other implementation capable of processing and executing software. The term processor should not be construed to refer exclusively to hardware capable of executing software, and may implicitly include DSP hardware, ROM for storing software, RAM, and any other volatile or non-volatile storage medium. In one embodiment, the start-up operations includes memory initialization and sizing.

The method and apparatus for BIOS loading further includes a central processing unit (CPU) having a cache memory. The CPU maybe of the standard host processing unit in a computing system or any other adjunct or secondary processor associated with a computer processing system. The CPU maybe a processor may be, but not limited to, a single processor, a plurality of processors, a DSP, a microprocessor, ASIC, state machine, or any other implementation capable of processing and executing software. The term processor should not be construed to refer exclusively to hardware capable of executing software, and may implicitly include DSP hardware, ROM for storing software, RAM, and any other volatile or non-volatile storage medium.

In the method and apparatus for BIOS loading, the startup operation includes a power on self-test (POST) operation, in accordance with standard BIOS loading operations. Although, in the present invention, the system BIOS programs CPU MSR registers to make CPU write and read data to the cache memory prior to the operations of system memory initialization and sizing Therefore, the system BIOS software, through the utilizing the cache memory of the CPU, is able to perform a greater level of computations with a greater degree of flexibility for performing system memory initialization and sizing.

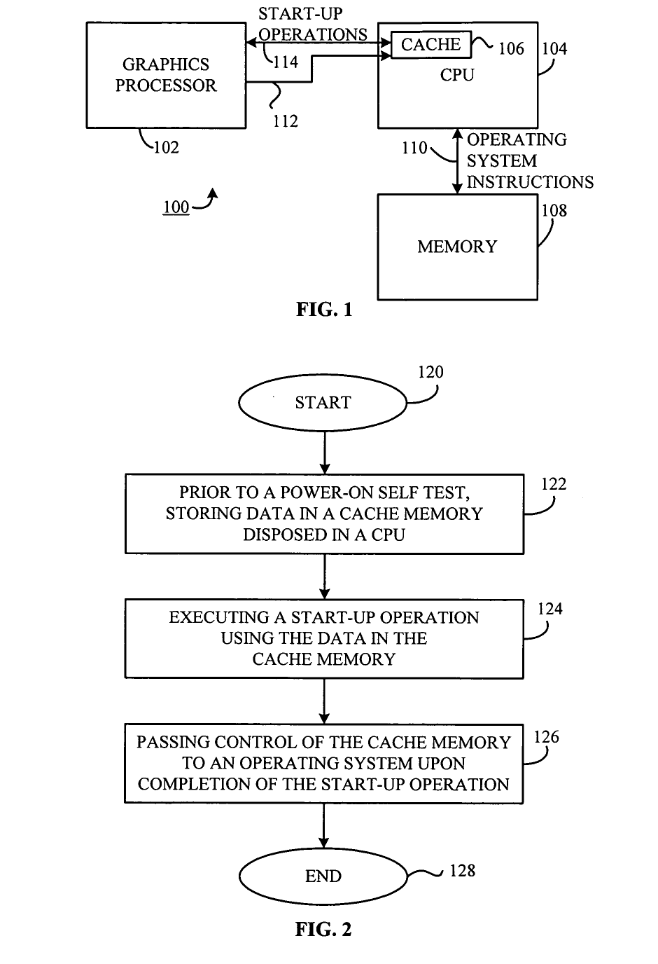

More specifically, FIG. 1 illustrates an apparatus for BIOS loading 100 including a graphics processor 102, CPU 104 having a cache 106 and a memory 108. The graphics processor 102 maybe any suitable processor. The CPU 104 maybe any suitable central processing unit, such as but not limited to a Pentium processor available by Intel.

The cache 106 disposed within the CPU 104 may be any suitable type of memory location internal to the CPU 104. The cache 106 may be, but not limited to, a signal memory, a plurality of memory locations, shared memory, RAM, or any other storage medium capable of storing digital data. In one embodiment, the cache 106 maybe a level 1 cache (L1). In another embodiment, the cache 106 maybe a level 2 cache (L2).

The memory 108 is coupled to the CPU 104, wherein the memory 118 stores operating system instructions 110. Examples of an operating system instructions include instructions for any suitable operating system, such as but not limited to a Windows operating system instructions available from Microsoft, Inc., Linux operating system available from Red Hat and OS X available from Apple Computers. The memory 108 maybe, but not limited to, a single memory, a plurality of memory locations, shared memory, CD, DVD, ROM, RAM, EEPROM, optical storage, microcode, or any other storage medium capable of storing operating system instructions.

The graphics processor 102 is further coupled to the CPU 104, wherein prior to loading operating systems instructions 110 from the memory 108 to the CPU 104, the graphics processor is capable of BIOS software loading through accessing the cache 106 within the CPU 104. The graphics processor 102 writes a plurality of data 112 to the cache 106 to initialize the cache 106 and to designate the cache's 106 storing data for use by the graphics processor 102 prior to the CPU 104 operating the operating system instructions 110. Upon designating the cache 106, the graphics processor 102 thereupon performs startup operations 114 through utilizing a plurality of executable commands for performing the functions of starting up the processing of the graphics processor 102.

In one embodiment the start-up operation performed by the graphics processor 102 includes a power-on self-test operation to implement the system memory initialization and sizing. Moreover, the graphics processor 102 may allocate, through the command 112, a particular portion of memory spaced within the cache 106 for performing the specific operations 114. Therefore, the graphics processor 102 may not utilize the full cache 106, but may accurately and appropriately use a requisite portion sufficient to improve the processing speed and processing abilities for the graphics processor 102 in the start-up operations 114. Moreover, through the utilization of the cache 106, instead of standard registers associated with the CPU 104, the start-up operations may utilize a greater degree of instructions to manipulate the data and code within the stack segment. For example, operations such as CALL, PUSH, and POP maybe utilized without delaying or having an extensive burden on system resources. Therefore, by utilizing the cache 106, the graphics processor 102 utilizes the cache memory to provide a flexible implementation system BIOS before the system memory (not shown) is available for the graphics processor 102.

Consistent therein, the graphics processor 102, accesses and utilizes the cache 106 without approval or knowledge of the CPU 104. When the operating instructions 110 are provided to the CPU 104, the data within the cache 106 is flushed and the CPU 104 resets and effectively utilizes the cache 106 in accordance with normal operations. Therefore, the graphics processor 102 may perform the BIOS loading utilizing the cache 106 without adverse affect to the CPU 104 or the operating system instructions as long as the access to the cache 106 is performed prior to the operating system instructions 110 being executed by the CPU 104.

FIG. 2 illustrates a graphical representation of a flowchart representing the steps of one method for BIOS loading. The method, begins, step 120 by storing data in a cache memory disposed in the CPU prior to a power-on self test, 122. As described above, the cache 106 is disposed within the CPU 104 and the data 112 is stored within the cache 106 prior to startup operations 114.

Step 124 is executing a startup operation using the data in cache memory. As discussed above with respect to FIG. 1, through the utilization of the cache 106, the startup operations 114 may include a greater degree of flexibility of operations, such as CALL, PUSH and POP, before the CPU 104 seeks to take control of the cache 106. The start-up operation may be a memory sizing and initialization routine.

Step 126 is passing control of the cache memory to operating system upon completion of the startup operation. In this embodiment, the startup operation must be performed within a predefined time period, typically before the system BIOS starts to perform the system memory initialization and sizing code. Upon passing control of the cache memory, the contents of the cache 106 are flushed and the memory 106 is thereupon reinitialized. Thereupon, this embodiment of the method is complete step 128.

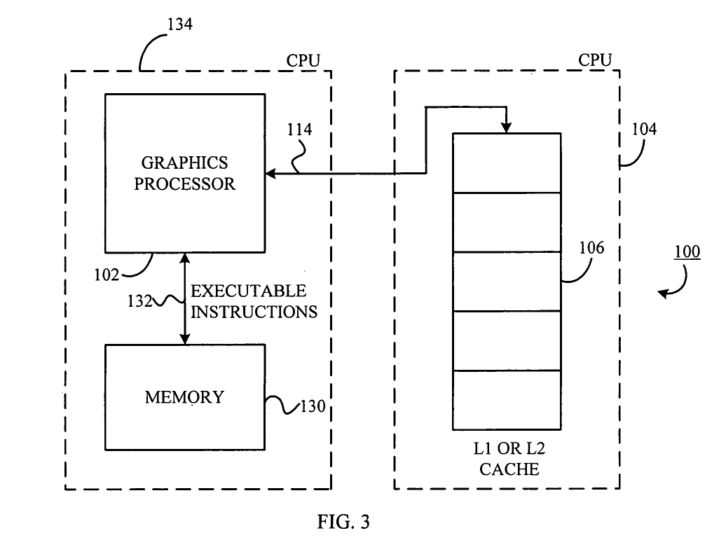

FIG. 3 illustrates another embodiment of the apparatus 100 for BIOS loading. The apparatus includes the graphics processor 102, the CPU 104 having the memory 106 which maybe a L1, L2 cache. A memory 130 is coupled to the graphics processor 102 wherein the memory 130 stores executable instructions 132 that are provided to the graphics processor 102. The memory 130 may be, but not limited, to a single memory, plurality of memory locations, shared memory, CD, DVD, ROM, RAM, EPROM, optical storage, microcode or any other volatile or non-volatile storage median capable of storing the executable instructions 132.

In one embodiment, the graphics processor 102 and the memory 130 are disposed within a graphics processing unit (GPU) 134. Furthermore, in one embodiment, the graphics processing unit 134 and the CPU 104 maybe disposed within a common chip set for providing communication there a crossed. The graphics processor 102 is operative to perform the startup operations 114 utilizing the memory 106.

In one embodiment, the graphics processor may perform memory initialization and sizing operations by setting a MTRR_FIXED_ENABLE bit and a MTRR_ENABLE in a MTRR_DEF_TYPE of a model specific register. The next step maybe to set MTRRfix4k_C000in the model specific register with a write back (06) command. In this embodiment, this operation allows the cache memory to always hit in a read/write memory operation, therefore the cache memory will be refilled and the system memory will not be written to, because the system memory is unavailable during the BIOS loading.

In one embodiment, the next command is to clear a CD bit 30 and NW bit 29 in a CR0 register, thereby enabling cache memory in a right policy for a system memory location. The next step is to assign and SS register with C000H, assign SP with 1024×4, assigned DS with C000H. Therefore, the system allows the data and stack segment to implement code before the system memory is available. The operations 114 allow for the utilization of the memory 106 during memory initialization and sizing. The above noted operations represent one exemplary embodiment an encoded operation for executable commands prior to doing a memory initialization sizing, but any of the suitable commands providing for the same functionality, as described above, maybe performed and are within the scope of the present invention, as recognized by one having ordinary skill in the art.

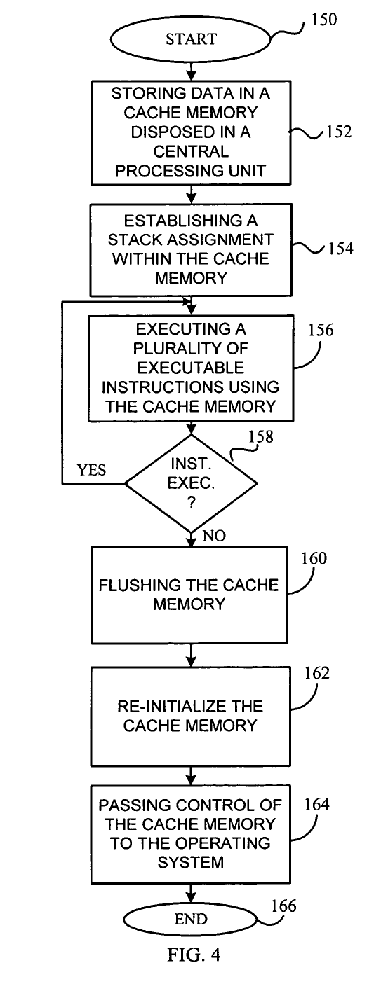

FIG. 4 illustrates a flowchart representing method for BIOS loading in accordance with another embodiment of the present invention. The method begins 150 by storing data and a cache memory disposed in a CPU 152. As discussed above, step 152 is performed prior to the execution of an operating system executing operating system instructions. In step 152, the data stored in the cache memory is utilized for the purpose of allowing for subsequent memory system and initialization steps. Step 154 is establishing a stack assignment within the cache memory, such as assigned the values to the CPU registers SS and SP.

Step 156 is then executing a plurality of executable instructions using the cache memory. As illustrated in FIG. 3 executable instructions 132 are executed by the graphics processor 102 and the memory 106 is utilized to help facilitate data manipulation, including the conclusion of among other things executable commands including CALL, PUSH or POP commands which are allowable based on the size of the memory 106. Step 158 is a determination if there are any executable instructions. In the event there are further executable instructions, the method proceeds to step 156 where the plurality of the executable instructions are further executed using the cache memory. In the event there are no more executable instructions, one embodiment of the method proceeds to step 160, flushing the cache memory. The cache memory is flushed such that the CPU may thereupon utilize the cache memory for internal operations in accordance with standard central processing unit operations, such as performing instructions related to the operating system.

Step 162 is reinitializing the cache memory upon the completion of step 160, flushing the cache memory so that the cache memory is reinitialized and the CPU may adequately and efficiently use the cache memory in accordance with its own standard techniques. The operations of steps 152 through 156 do not adversely affect or interfere with normal CPU operations, but are performed in one embodiment without the knowledge or consent of the CPU prior to the CPU using the particular cache or in another embodiment, a particular portion of the cache.

Step 164 is passing control of the cache memory to the operating system. The operating system, through executing operating system instructions on the host CPU controls the cache memory, whether the cache memory be an L1 or an L2 cache memory or any other suitable memory native to the central processing unit. Thereupon, one embodiment of the method is complete, step 166.

The present invention improves BIOS loading in a graphics processing unit by utilizing cache memory within a host CPU instead using external registers. The method and apparatus of the present invention improves by not only performing faster and improved operations, but also provides a greater degree of flexibility in programming the setup operations for the graphics processing unit, more specifically the graphics processor. Through using the cache memory prior to and without knowledge of the central processing unit, the CPU can effectively use the cache memory in accordance with normal CPU operations and the benefits of using cache memory for graphics processing BIOS loading with extended memory resources instead of the limited register memory resources maybe realized.

It should be understood that the implementation of other variations and modifications of the invention in its various aspects will be apparent to those of ordinary and skill in the art, and that the invention is not limited by the specific embodiments described herein. For example, the graphics processor maybe any suitable processing unit associated for the purpose of processing graphics wherein the graphics processor operates in accordance with a host central processing unit, including a standard chipset or the processors communicating across one or more buses or any other suitable configurations allowing for graphics processing in accordance with central processing instructions by a CPU. It is therefore contemplated to cover by the present invention, any and all modifications, variations, or equivalents that fall within the spirit and scope of the basic underlying principals disclosed and claimed herein.

1. A method for basic input output system loading for a personal computer, the method comprising:
prior to the availability of system memory, storing data in a cache memory disposed in a central processing unit; and
executing a memory initialization and sizing operation using the data in the cache memory.

2. The method of claim 1 wherein the start-up operation includes a power on self test operation.

3. The method of claim 1 wherein the cache memory is a level one cache.

4. The method of claim 1 wherein the cache memory is a level two cache.

5. The method of claim 1 wherein the start-up operation includes a memory sizing operation.

6. The method of claim 1 wherein the step of passing control of the cache memory includes:
flushing the cache memory; and
re-initialize the cache memory.

7. The method of claim 1 wherein the start-up operation is performed by a graphics processor operablely coupled to the central processing unit.

8. The method of claim 7 wherein the graphics processor is disposed within a chipset.

9. An apparatus for basic input output system loading, the apparatus comprising:
a graphics processor having a start-up operation.
a central processing unit having a cache memory; and
the graphics processor writing data to the cache memory prior to the start-up operations.

10. The apparatus of claim 9 wherein the start-up operation performed by the graphics processor includes a power on self test operation.

11. The apparatus of claim 9 wherein the start-up operation performed by the graphics processor includes a memory sizing operation.

12. The apparatus of claim 9 wherein the cache memory is a level one cache.

13. The apparatus of claim 9 wherein the cache memory is a level two cache.

14. The apparatus of claim 9 wherein the graphics processor flushes the data from the cache memory and the central processing unit re-initializes the cache memory.

15. The apparatus of claim 14 wherein the central processing unit thereupon utilizes the cache memory.

16. The apparatus of claim 15 wherein the graphics processor is disposed within a chipset.

17. A method for basic input output system loading in a graphics processor, the method comprising:
prior to the execution of an operating system, storing data in a cache memory disposed in a central processing unit;
establishing a stack assignment within the cache memory;
executing a plurality of executable instructions using the cache memory; and
upon execution of the executable instructions:
flushing the cache memory; and
re-initialize the cache memory; and
passing control of the cache memory to the operating system.

18. The method of claim 17 wherein the executable instructions include a power on self test operation.

19. The method of claim 18 wherein the executable instruction are performed by a graphics processing unit.

20. The method of claim 19 wherein the cache memory is at least one of: a level one cache and a level two cache.
